(19) United States
(12) Patent Application Publication
(10) Pub. No.: US 2025/0127249 A1
(43) Pub. Date: Apr. 24, 2025

(54) GARMENT MATERIAL

(71) Applicant: ATG Ceylon (Pvt) Limited, IPZ Katunayake (LK)

(72) Inventors: Mohamed Fazal Abdeen, Colombo (LK); Sunil Mendis, Gampaha (LK); Andrew Goth, San Diego, CA (US); John Taylor, Shropshire (GB)

(21) Appl. No.: 18/383,116

(22) Filed: Oct. 24, 2023

(51) Int. Cl. A41D 19/00; A41H 43/00; B29D 99/00; B29K 105/08; D04B 1/28; D04B 21/20

(52) U.S. Cl. CPC A41D 19/0006; A41D 19/001; A41D 19/0058; A41H 43/00; B29D 99/0067; D04B 1/28; D04B 21/207; A41D 2500/10; B29K 2105/0836

(57) ABSTRACT

A garment material comprising: a first layer, wherein the first layer is a shaped polymer; a second layer, wherein the second layer is a shaped polymer that is provided at one or more locations on the first layer, the second layer taking the shape of the first layer at said one or more locations; and a textile layer; wherein the second layer is located between the first layer and the textile layer; wherein the second layer comprises a liner embedded in the shaped polymer of the second layer, the liner being formed of yarn and there are interstices through the liner, and wherein: the yarn of the liner has a weight per length of 10 to 60 Dernier; and the liner has a weight per area in the garment material or in a region of the garment material that is from 5 to 35 g/m².

### FIELD OF THE INVENTION

The present invention relates to a garment material and to garments, such as gloves, comprising the garment material. The present invention relates to methods of making the garment material.

### BACKGROUND OF THE INVENTION

Single use disposable garment materials, such as gloves, are very commonly used in a variety of medical and non-medical applications, such as for scientific laboratories, for food preparation or for janitorial work.

These gloves are usually made from a single layer of a polymer material, such as latex, nitrile rubber (i.e. nitrile butadiene rubber, NBR), polyvinyl chloride (PVC) or neoprene, which provide a degree of protection for the hands of a user against certain chemical and biological agents. Single use disposable gloves provide excellent dexterity for the user, allowing them to perform tasks accurately whilst receiving protection from the glove.

However, the protection afforded by single use disposable gloves leaves is far from optimal in many situations. In particular, the mechanical strength of single use disposable gloves is poor. Specifically, single use disposable gloves display poor tear, cut and abrasion resistance. Once torn, cut or abraded, any chemical or biological protection afforded by single use disposable gloves is negated.

Furthermore, the low mechanical strength of single use disposable gloves means that they can only reliably be used once. They are not resilient enough to be used multiple times and/or washed. Polymer materials used for single use disposable gloves are not biodegradable. Therefore, single use disposable gloves typically require disposal in landfill.

Single use disposable gloves are made on ambidextrous hand formers and are not specifically tailored to be used on either hand. This can cause the gloves to fit hands poorly and to crease significantly, causing a reduction in the dexterity of the user and providing the potential for the single use disposable gloves to snag on machinery, causing risk to the user.

While high mechanical strength and washability has previously been attained with gloves, such properties traditionally require glove material to be thick and come with a significant detriment to the dexterity of the user and to the comfort of the user.

The present invention has been devised with the foregoing in mind.

### SUMMARY OF THE INVENTION

According to a first aspect the present invention provides a garment material comprising: a first layer, wherein the first layer is a shaped polymer; a second layer, wherein the second layer is a shaped polymer that is provided at one or more locations on the first layer, the second layer taking the shape of the first layer at said one or more locations; and a textile layer; wherein the second layer is located between the first layer and the textile layer; wherein the second layer comprises a liner embedded in the shaped polymer of the second layer. The liner is made of yarn and there are interstices through the liner. The yarn of the liner has a weight per length of 10 to 60 Dernier; and the liner has a weight per area in the garment material or in a region of the garment material that is from 5 to 35 g/m².

The garment material of the present invention can be recycled by washing multiple times, enabling the number of garments, such as gloves, that would need to be disposed of to be significantly reduced, and therefore reducing the environmental impact of conventional garments.

While all gloves reduce the dexterity of the wearer to some extent, it is preferable to reduce the impact of a glove on the wearer's dexterity and comfort. The garment material displays excellent dexterity characteristics.

Gloves made of the garment material can be shaped to specifically fit each hand of a wearer, which allows the glove to fit more closely to the wearer's hand compared to ambidextrous gloves that fit either hand. This can reduce the amount of creasing of the glove during use, which can increase the comfort and dexterity of the user when wearing the gloves compared to similar but ambidextrous gloves. The use of anatomically designed gloves can reduce the risk of the glove catching in machinery, thereby reducing the risk of damage to the wearer's hand during use, compared to similar but ambidextrous gloves.

Preferably the thickness of the garment material is from 0.1 mm to 1.0 mm, such as from 0.3 mm to 0.7 mm, which provides benefits to the dexterity of the user.

The garment material can also display significantly better physical properties than materials of single use disposable gloves in at least three distinct ways. For example, gloves made of the garment material of the invention has been found to have:
a cut resistance that is 6% higher than conventional single use disposable gloves,
an abrasion resistance that is from 63% to 2800% higher than conventional single use disposable gloves, and
a tear resistance that is from 600% to 1700% higher than conventional single use disposable gloves.

Garment materials, and gloves, with a subset of the above desirable properties are known, but known garment materials do not exhibit all of these properties, or do not exhibit them to as great a degree as is desirable, especially with a desired level of dexterity and comfort to the user.

Garments that include a liner embedded in a polymeric material are known as supported garments. It was previously considered that dexterity would always be significantly impacted with using a supported glove, as compared to an unsupported glove that does not contain a liner.

However, the present inventors have surprisingly found that excellent dexterity can be retained simultaneously with improved cut resistance, improved abrasion resistance and improved tear resistance, and in a garment material (e.g. glove) that can be recycled multiple times by washing.

According to a second aspect the present invention provides a garment comprising the garment material of the first aspect. The garment may be a coat (e.g. raincoat), an apron, a hood, a boot, a shoe, a sock, overalls, waders, trousers or a glove.

Preferably the garment is a glove. Preferably the garment is a glove wherein the liner has a weight per area in the palm and/or finger region of the glove of from 5 to 35 g/m².

Where the garment is a glove, preferably the thickness of the garment material in the region of the palm and/or fingers of the glove is from 0.1 mm to 1.0 mm, such as from 0.3 mm to 0.7 mm, which provides benefits to the dexterity of the user.

WO 2019/229427 A1 discloses gloves made of natural rubber (NR) or nitrile butadiene rubber (NBR) that have a liner comprising “41% 100 D Dyneema® (UHMWPE), 22% 50 D fibre glass yarn and 37% nylon 6 yarn”, wherein the liner has a weight per area on the palm area of 117 g/m² (11.7 mg/cm²), and wherein the glove has three coatings comprising natural rubber in the first layer. WO 2019/229427 A1 does not disclose a liner having a yarn with a weight per length of 10 to 60 Dernier, and that has a weight per area in the garment material or in a region of the garment material that is from 5 to 35 g/m².

The gloves of the present invention provide significant and surprising benefits in terms of the reduction of impact of the glove on the dexterity and comfort of the user when compared to traditional gloves, such as those disclosed by WO 2019/229427 A1, whilst being able to maintain key properties such as chemical resistance and mechanical resistance.

According to a third aspect the present invention provides a method of making a garment material, the method comprising: providing a first layer, which is a shaped polymer; applying a liner to the first layer, wherein the liner is formed of yarn and there are interstices through the liner; applying a fluid polymeric material to the liner such that the fluid polymeric material permeates the interstices of the liner; allowing the fluid polymeric material to solidify to thereby form a second layer comprising the liner embedded in the solid polymeric material; and applying fibres to form a textile layer. The yarn of the liner has a weight per length of 10 to 60 Dernier, and the liner has a weight per area in the garment material or a region of the garment material that is from 5 to 35 g/m². The garment material of the first aspect and/or the garment of the second aspect may be obtainable (e.g. obtained) by the method of the third aspect.

It will be appreciate that embodiments disclosed in relation to one aspect of the invention apply equally to the other aspects of the invention, unless they are incompatible.

### DETAILED DESCRIPTION OF THE INVENTION

The garment material may form a glove that is impermeable to liquid and resistant to corrosion by chemicals, so as to protect the wearer's hand. Preferably the garment material forms at least part (e.g. 50% by area or more, such as all) of the finger area and/or palm area of the glove.

It will be understood that the garment material, garment or section of garment is flexible. The garment material of the present invention is suitable for producing a range of garments. Garments comprising the garment material may be a coat (e.g. raincoat), an apron, a boot, a shoe, a sock, overalls, waders, trousers and/or a glove.

The thickness of the garment material is preferably 1.0 mm or less, such as 0.8 mm or less, or 0.7 mm or less, especially 0.6 mm or less, such as 0.5 mm. The thickness of the garment material may be 0.1 mm or more, such as 0.3 mm or more, or 0.4 mm or more, such as 0.5 mm. The thickness of the garment material may be from 0.1 mm to 1.0 mm, preferably from 0.3 mm to 0.7 mm, or from 0.4 mm to 0.6 mm.

The first layer may have a total thickness of 0.6 mm or less, such as 0.4 mm or less, and the second layer may have a thickness of 0.6 mm or less, such as 0.4 mm or less. The first layer may have a total thickness of from 0.001 mm to 0.6 mm, such as from 0.01 mm to 0.3 mm, and the second layer may have a thickness of from 0.001 mm to 0.6 mm, such as from 0.01 mm to 0.3 mm.

In embodiments the garment is seamless i.e. it is made of one piece of garment material rather than being made from two or more pieces of garment material that are joined together (e.g. by stitching). A seamless garment may be achieved by making the garment on a former having a shape corresponding to the garment.

### First Layer

The first layer corresponds to the outermost layer of the garment when in use. The first layer of the garment material and/or garment may have an outer surface (i.e. the surface not in contact with the second layer) wherein some or all of the outer surface is textured (e.g. bumpy or rough, rather than smooth).

The first layer may comprise a single layer of polymeric material. The first layer may comprise two or more sub-layers (or coatings) of polymeric material. Preferably the first layer comprises from one to three sub-layers of polymeric material. Most preferably the first layer comprises two sub-layers of polymeric material.

The ability to vary the number of sub-layers in the first layer of multiple sub-layers can provide benefits in terms of varying the thickness of the resulting garment material, and therefore the resistance of the garment material to chemical agents and/or physical actions. For a glove, it can be useful to have a thicker material from the fingers to the wrist (more sub-layers), and thinner material for the cuff (fewer sub-layers) to provide higher mechanical strength to the glove in these regions, which typically experience more physical action. Multiple sub-layers are useful since they allow a number of different polymeric materials to be employed in the first layer. For example, it may be desirable for the outermost coating to have different properties (chemical resistance, colour etc.) from an inner coating.

It will be understood that the first layer and the resulting garment material are typically flexible. It is desirable for a garment material to be flexible so that the resulting garment is comfortable and allows the wearer to move freely. The use of a lower number of sub-layers of polymeric material can reduce the thickness of the first layer, thereby reducing the detriment to the dexterity of the user caused by the garment (e.g. glove).

The shaped polymer of the first layer may have the shape of a complete garment, e.g. a glove, sock, shoe or boot, or the shaped polymer may have the shape of a section of such a garment. If sheets of garment material are required then the shaped polymer of the first layer may be a polymer sheet. Preferably the first layer is shaped as a glove (i.e. hand-shaped).

A wide range of polymeric materials are suitable for the first layer. The polymer of the first layer may be a polymer, or a blend of polymers selected from the list consisting of acrylic latex, NBR, nitrile latex, natural latex, polyvinylchloride (PVC), polyvinylacetate (PVA), neoprene (polychloroprene), PU latex, butyl rubber (a copolymer of isobutylene with isoprene, also known as IIR), polyisobutylene (also known as “PIB” or polyisobutene rubber), polyvinyl alcohol, and fluoropolymer elastomer (including those sold under the VITON® brand.

The first layer may comprise a polymer, or a blend of polymers, selected from the list consisting of acrylic latex, nitrile latex, natural latex, neoprene, and butyl rubber.

The first layer preferably comprises (e.g. consists essentially of, or consists of) two sub-layers, wherein each sub-layer comprises (e.g. consists essentially of, or consists of) a blend of latexes selected from acrylic latex, nitrile latex and natural latex.

The first layer may have a total (i.e. including any sub-layers) thickness of 0.6 mm or less, or 0.4 mm or less, preferably 0.3 mm or less, for example 0.2 mm or less, or 0.19 mm or less. The first layer may have a total thickness of 0.001 mm or more, or 0.01 mm or more, such as 0.05 mm or more, such as 0.07 mm or more, or 0.08 mm or more. The total thickness of the first layer may be from 0.001 mm to 0.6 mm, such as from 0.01 mm to 0.3 mm, such as from 0.07 mm to 0.2 mm. The first layer is flexible.

### The Second Layer

The second layer is supported on the first layer. The second layer covers some or all of the first layer and, where it covers the first layer, it has a corresponding shape to the first layer.

The second layer may be formed by applying a fluid polymeric material to the liner to permeate the interstices in the liner. The fluid polymeric material can then be allowed to solidify and form the second layer in which the liner is embedded in the solid polymeric material. It will be understood that the resulting solid polymeric material (and the second layer) is flexible, rather than rigid.

The fluid polymeric material covers some or all of the first layer and will inevitably conform with the shape of the part or all of the first layer. Hence, the first and second layers are aligned. In one embodiment the fluid polymeric material of the second layer covers all of the first layer.

It will be understood that sufficient fluid polymeric material must be applied to completely cover and coat the liner. If absorbent, the liner may be “soaked” with the fluid polymeric material. Hence, the second layer will have a minimum thickness that corresponds to the thickness of the liner. Moreover, excess fluid polymeric material may be applied such that the thickness of the second layer is greater than the thickness of the liner.

The second layer may have a thickness of 100% or more, or 120% or more, such as 150% or more, or 180% or more, for example 200% or more of the thickness of the liner. The second layer may have a thickness of 400% or less, such as 300% or less, or 200% or less, for example 150% or less, or 130% or less of the thickness of the liner. The thickness of the second layer may be from 100% to 400% of the thickness of the liner, such as from 100% to 200%, or from 100% to 150%. While it is possible to apply a thick coating in which the liner is embedded, this increases the overall thickness of the garment material and therefore reduces the flexibility of the garment material and the dexterity of gloves made from the material.

The second layer (which comprises the liner) may have a thickness of 0.6 mm or less, thickness of 0.6 mm or less, or 0.4 mm or less, preferably 0.3 mm or less, for example 0.27 mm or less, or 0.25 mm or less. The second layer may have a thickness of 0.001 mm or more, or 0.01 mm or more, such as 0.05 mm or more, for example 0.10 mm or more, or 0.15 mm or more, for example 0.18 mm or more, or 0.20 mm or more. The thickness of the second layer may be from 0.001 mm to 0.6 mm, such as from 0.01 mm to 0.3 mm, such as from 0.15 mm to 0.27 mm.

The polymer of the second layer may be a polymer or a blend of polymers selected from the list consisting of acrylic latex, nitrile butadiene rubber (NBR), nitrile latex, natural latex, polyvinylchloride (PVC), polyvinylacetate (PVA), neoprene (polychloroprene), PU latex, butyl rubber (a copolymer of isobutylene with isoprene, also known as IIR), polyisobutylene (also known as “PIB” or polyisobutene rubber), polyvinyl alcohol, and fluoropolymer elastomer (including those sold under the VITON® brand.

The polymer of the second layer may be a polymer or a blend of polymers selected from the list consisting of acrylic latex, NBR, nitrile latex, natural latex, neoprene, and/or butyl rubber.

The polymer of the second layer may be a polymer or a blend of polymers selected from the list consisting of acrylic latex, NBR and acrylic latex.

The fluid polymeric material may be applied by dipping. i.e. the first layer having the liner applied thereto is dipped into (or immersed in) a container (e.g. a bath or trough) containing the fluid polymeric material e.g. a solution or suspension of the polymeric material, optionally with other components.

The fluid polymeric material may be applied directly to the liner (i.e. without first applying a coagulant to the liner). A coagulant is often used in a conventional method to help the fluid polymeric material coagulate on a substrate. However, the use of a coagulant on the liner would hinder the fluid polymeric material (effectively a bonding coating) soaking into the liner.

Preferably excess polymer of the second layer is allowed to drain from the former. Preferably the former is rotated to evenly distribute the polymer during and/or after the draining step.

In the context of the present invention a coagulant is an aqueous or alcoholic solution of electrolytes. Suitable electrolytes include formic acid, acetic acid, calcium chloride, calcium nitrate, zinc chloride or a mixture of two or more of these. Methanol is typically used to provide the alcoholic solution but other alcohols are also suitable, for example, iso-propyl alcohol and ethanol may also be used. The coagulant may have a concentration (strength) of electrolytes of from 5% to 15% by weight.

The fluid polymeric material may be solidified by coagulating the fluid polymeric material. A coagulant may be applied to the fluid polymeric material to solidify it to form the second layer. Coagulant may be applied to the second layer and then dried (e.g. by the application of heat with optional rotation).

The fluid polymeric material may be solidified by the application of heat. Solidifying may comprise curing the fluid polymeric material, for example by applying heat.

The fluid polymeric material may be a plastisol. A plastisol is a suspension of plastics particles (e.g. PVC particles) in a liquid plasticizer. When heated (e.g. to around 177° C.), the particles and plasticizer mutually dissolve each other. On cooling (e.g. to below 60° C.), a flexible, permanently plasticized solid product results.

The application of heat may be done in an oven which may be fitted with one or more fans that distribute the heat evenly throughout the oven. The heating could also be achieved by directing hot air over the second layer.

The viscosity of the fluid polymeric material may be adjusted to ensure that it permeates the interstices of the liner. For example, the viscosity may be reduced as compared to a conventional supported glove.

Viscosity can be measured using a Brookfield Viscometer Model RVDV-E, Spindle #1 and should be quoted with the speed of rotation, e.g. Speed 2 RPM, and the temperature of measurement e.g. 30 to 32° C.

The fluid polymeric material may have a viscosity of no more than 10 Pas (=10 Ns/m²⁼¹⁰⁰ poise), no more than 5 Pa s, or no more than 2 Pa s, when measured using a Brookfield Viscometer Model RVDV-E, Spindle #1, speed 2 RPM, 30-32° C.

The fluid polymeric material may have a viscosity of from 1 to 2 Pa s, when measured using a Brookfield Viscometer Model RVDV-E, Spindle #1, speed 2 RPM, 30-32° C.

### Liner

The liner is made of a yarn that is defined with reference to its Denier (D). Denier is the mass in grams per 9000 meters of the yarn. A lower Denier corresponds to a lighter yarn per length of the yarn.

Specifically, the yarn of the liner has a weight per length of from 10 to 60 Dernier. The yarn may have a weight per length of from 10 to 55 Dernier, preferably from 10 to 50 Dernier, or from 10 to 45 Dernier, such as from 10 to 42 Dernier, or from 10 to 40 Dernier. The yarn may have a weight per length of from 15 to 60 Dernier, such as from 20 to 60 Dernier, preferably from 25 to 60 Dernier, or from 30 to 60 Dernier, for example 35 to 60 Dernier, or 38 to 60 Dernier. The weight per length of the yarn may be from 25 to 50 Dernier, such as from 35 to 45 Dernier, or from 38 to 42 Dernier.

The liner is defined in terms of its weight per area in the garment material or a region thereof. Specifically, the liner has a weight per area in the garment material or a region thereof, of from 5 to 35 g/m² (50 to 350 g/m²). The liner in the garment material or a region thereof may have a weight per area of 10 g/m² or more, preferably 15 or more, such as 18 g/m² or more, or 19 g/m² or more, or 20 g/m² or more. The liner in the garment material or a region thereof may have a weight per area of 30 g/m² or less, preferably 27 g/m² or less, such as 24 g/m² or less, or 23 g/m² or less, or 22 g/m² or less. The liner in the garment material or a region thereof may have a weight per area of from 15 to 27 g/m², such as from 18 to 24 g/m², or from 20 to 22 g/m².

The yarn of the liner may have a weight per length of from 25 to 50 Dernier where the liner in the garment material or a region thereof has a weight per area of from 15 to 27 g/m². For example, the yarn of the liner may have a weight per length of from 38 to 42 Dernier where the liner in the garment material or a region thereof has a weight per area of from 20 to 22 g/m².

Where the garment is a glove, the liner may have a weight per area on the palm and/or finger area of from 5 to 35 g/m² (50 to 350 g/m²). The palm and/or finger area of the liner in the glove may have a weight per area of 10 g/m² or more, preferably 15 or more, such as 18 g/m² or more, or 19 g/m² or more, or 20 g/m² or more. The palm and/or finger area of the liner in the glove may have a weight per area of 30 g/m² or less, preferably 27 g/m² or less, such as 24 g/m² or less, or 23 g/m² or less, or 22 g/m² or less. The palm and/or finger area of the liner in the glove may have a weight per area of from 15 to 27 g/m², such as from 18 to 24 g/m², or from 20 to 22 g/m².

The liner may be similar to those employed in conventional supported gloves, yet is significantly lighter than liners used in conventional supported gloves. It is surprising that the present invention can use a significantly lighter liner and achieve the benefits of enhanced cut, tear and abrasion resistance whilst also maintaining a dexterity similar to that of a conventional single use disposable glove. The particular combination of benefits achieved by the present invention has not previously been realised.

The total weight of liner in a garment (e.g. glove) made from the garment material may be 1.0 g or more, or 1.5 g or more such as 2.0 g or more, such as 2.5 g or more, or 2.8 g or more, for example 3.0 g or more. The total weight of liner in a garment made from the garment material may be 6.5 g or less, such as 6.0 g or less, or 5.5 g or less, for example 5.0 g or less, for example 4.5 g or less, or 4.0 g or less, for example 3.5 g or less. The total weight of liner in a garment made from the garment material may be from 1.0 g to 6.5 g, such as from 2.0 g to 4.5 g, for example from 2.5 g to 4.0 g, or from 3.0 g to 3.5 g.

Where the garment is a glove, the liner may have a weight per area on the cuff area of 10 g/m² or more, such as 15 g/m² or more, or 20 g/m² or more, such as 25 g/m² or more, or 30 g/m² or more, such as 33 g/m² or more. The liner may have a weight per area on the cuff area of 60 g/m² or less, such as 50 g/m² or less, or 45 g/m² or less, for example 40 g/m² or less, or 37 g/m² or less, such as 35 g/m² or less. The liner may have a weight per area on the cuff area of from 10 to 60 g/m², such as from 20 to 50 g/m², or from 30 to 37 g/m².

The liner is applied to the first layer, which is a shaped polymer. The first layer is solid (rather than fluid) when the liner is applied to allow easy “dressing” of the liner. In embodiments the first layer is obtained by fully drying a polymeric material.

The liner may be formed by knitting, weaving or some other known process. The liner has interstices through it and may be considered to be a lattice. It will be understood that the liner will take the shape of the first layer.

Preferably the liner is a knitted liner. The gauge of a knitting machine corresponds to the number of needles per inch (2.54 cm) of the knitting machine. The higher the gauge the lower the density of the lining. The liner may be formed using a knitting machine that has a gauge of 19 or more, such as 20 or more, for example 21. The gauge of the knitting machine may be 25 or less, such as 23 or less, or 22 or less. The gauge of the knitting machine may be from 19 to 25, preferably from 20 to 23, or from 20 to 22, most preferably 21.

The courses of a knitted material correspond to the (horizontal) rows of loops produced by all the adjacent needles during the same knitting cycle. In the palm area and/or the cuff area the number of courses per inch may be 20 or more, such as 25 or more, or 30 or more, for example 35 or more, or 40 or more, such as 43 or more. Preferably the courses per inch in the palm area is 43 or more. Preferably the courses per inch in the cuff area is 40 or more. In the palm area and/or the cuff area the number of courses per inch may be 70 or less, such as 65 or less, or 60 or less, for example 55 or less, or 50 or less, such as 47 or less, or 44 or less. In the palm area and/or the cuff area the number of courses per inch may be from 20 to 70, such as from 35 to 55, or from 40 to 50.

The wales of a knitted material correspond to the (vertical) columns of loops made by the equivalent needle in successive knitting cycles. In the palm area and/or the cuff area the number of wales per inch may be 10 or more, such as 15 or more, or 18 or more, or 20 or more, for example 21 or more. In the palm area and/or the cuff area the number of wales per inch may be 40 or less, such as 35 or less, or 30 or less, such as 25 or less, or 24 or less. In the palm area and/or the cuff area the number of wales per inch may be from 10 to 40, such as from 15 to 30, or from 18 to 25.

The yarn is preferably a multi-ply yarn, for example a two to six ply yarn. Most preferably the yarn is a two-ply yarn. Each ply may comprise two or more filaments, such as four or more filaments, preferably eight or more filaments, such as 10 or more, or 11 or more, most preferably 12 filaments. Each ply may comprise 20 or fewer filaments, such as 15 or fewer, or 13 or fewer filaments. Each ply may comprise from two to 20 filaments, such as from 8 to 15 filaments. The yarn may comprise from two to four, especially two, plies wherein each ply comprises two or more filaments, such as four or more filaments, preferably eight or more filaments, such as 10 or more, or 11 or more, most preferably 12 filaments. The yarn may comprise two or more filaments in total, such as 6 or more, or 10 or more, or 14 or more, preferably 18 or more, such as 20 or more, or 22 or more, or 23 or more, most preferably 24 filaments. The yarn may comprise 40 or fewer filaments

The liner is formed from yarn and may be produced from a wide range of yarn materials, for example, one of, or a blend of two or more of: cotton, nylon (polyamide), elastane (also known as Spandex™ or Lycra™), polyester (including CoolMax™), aramid (including Technora® and para-aramids such as Kevlar® and Twaron®), polyethylene (including ultra-high-molecular-weight polyethylene available under the brand names Dyneema® and Spectra®), fibre glass, acrylic, carbon (conductive) fibre, copper (conductive) fibre, Thunderon™ conductive fibre (copper sulfide chemically bonded to acrylic and nylon fibers), high strength liquid crystal polyesters (including the multifilament yarn spun from liquid crystal polymer available under the brand name Vectran™) and polyolefin fibres (including Viafil®). Preferably the yarn a nylon, such as nylon 6 (polycaprolactam).

It can be desirable for a garment (e.g. glove) to be cut and tear resistant so as to protect a wearer. A supported glove may be made where the lining is prepared from special cut resistant yarns when cut-resistance is required. However, such cut-resistant yarns are expensive compared to nylon and cotton yarns. Moreover, in some cases, they may still suffer from difficulties in terms of chemical corrosion.

It can be desirable for a protective glove to be cut and tear resistant, liquid impermeable and resistant to chemical corrosion so as to protect a wearer's hands. However, it is also desirable for such a protective glove to be lightweight and flexible, so as not to hinder the wearer's dexterity, and have an outer surface that provides good traction between the glove and an object being handled. It would also be desirable to provide a glove which is comfortable, so that a wearer is not inclined to remove the protective gloves in hazardous environments, e.g. by providing improved sweat absorption or dissipation properties.

The liner may include cut-resistant fibres. In the context of the present invention a “cut liner” is a liner formed of yarn comprising cut-resistant fibres. When a cut liner is employed the resulting garment material has greater cut-resistance than would be expected for a garment material with, for example, the same weight per area of liner but without cut-resistant fibres.

Suitable cut-resistant fibres include one of, or a blend of two or more of, aramid (including para-aramid), ultra-high-molecular-weight polyethylene (UHMWPE, e.g. Dyneema®), high strength polypropylene, high strength polyvinyl alcohol, high strength liquid crystal polyesters, and fibre glass. In embodiments the liner comprises ultra-high-molecular-weight polyethylene and/or fibre glass. The liner may comprise cut-resistant fibres and conventional fibres. The yarn may comprise at least one of (i) aramid, UHMWPE, fibre glass, carbon fibre, copper fibre, and high strength liquid crystal polyesters and/or at least one of (ii) cotton, nylon, elastane, polyester, and acrylic. The yarn may comprise a fibre (i) in an amount of 30 wt % or more, such as 50 wt % or more, or 60 wt % or more, and a fibre (ii) in an amount of 70 wt % or less, such as 50 wt % or less, or 30 wt % or less. The yarn may comprise a UHMWPE and a nylon.

It will be understood that the liner will usually be stretched over the first layer (that may be mounted on a former). As such, the un-stretched liner e.g., the liner as knitted, will have a greater weight/area than the stretched liner. Stretching the liner provides a more open construction i.e. the interstices in the substrate are enlarged.

The liner may be in the form of a sheet. In this case, a garment or garment section is produced by further processing of the sheets of garment material, for example by pieces being cut from the sheet of garment material and then the pieces being used to make a garment. The liner may be in a form that is a section of a garment, for example a pocket for a coat or a finger for a glove.

The liner preferably takes the form of a complete garment, such as a glove, a boot, a shoe or a sock. This means that the garment can be obtained directly, rather than having to join pieces of liner or garment material together. Such a garment may be seamless.

The method of the invention provides a garment material where a liner is embedded in a polymer i.e. the liner is completely coated or enveloped by the solid polymeric material. This is achieved by applying (“dressing”) the liner onto the first layer, coating the liner with the fluid polymeric material, and then applying a textile layer. The inventors have determined that “sandwiching” the liner within the garment material provides improved properties.

It is thought that the fluid polymeric material blocks the interstices in the knitted yarn and thereby “locks” the liner in place. Hence, the fluid polymeric material can be considered to be a “bonding” compound. This reinforces the garment material to provide strength and cut resistance. This reinforcement may be provided while maintaining flexibility.

In traditional supported gloves the liner is first fitted to a former (mould) and the subsequent coating only partially penetrates the liner; the liner is coated on just one side with polymeric material and therefore is not “embedded” as defined in the context of the present invention.

It is desirable to minimise the amount of penetration into the interstices since the liner is worn next to the skin. Therefore, if the polymeric material soaked through the liner this would mean direct contact between the polymer and this skin. This can cause irritation and build-up of perspiration next to the skin and, in particular, some wearers may be allergic to PU.

Specifically, it will be understood that the present invention is different from the disclosure of WO2010/022024. In WO2010/022024 a knitted liner is integrally bonded to a latex shell to provide a rough external texture with excellent grip properties. The liner is not “sandwiched” within the material, as in the present invention. In addition, if an electrostatic flock coating is applied to the glove of WO2010/022024, it is applied to the skin-contacting surface of the garment (not the external surface which provides grip).

In various embodiments:
the yarn of the liner has a weight per length of from 25 to 50 Dernier and the liner in the garment material or a region thereof has a weight per area of from 15 to 27 g/m²;
the yarn of the liner has a weight per length of from 35 to 45 Dernier and the liner in the garment material or a region thereof has a weight per area of from 18 to 24 g/m²;
the yarn of the liner has a weight per length of from 38 to 42 Dernier, and the liner in the garment material or a region thereof has a weight per area of from 20 to 22 g/m², wherein the yarn is a nylon yarn (e.g. nylon 6 yarn), and optionally wherein the liner is a knitted liner and is made by a knitting machine with a gauge of from 19 to 25;
the garment is a glove and the yarn of the liner has a weight per length of from 25 to 50 Dernier, and the palm and/or finger area of the liner in the glove has a weight per area of from 15 to 27 g/m², and optionally wherein the liner is a knitted liner and is made by a knitting machine with a gauge of from 19 to 25;
the garment is a glove and the yarn of the liner has a weight per length of from 35 to 45 Dernier, the palm and/or finger area of the liner in the glove has a weight per area of from 18 to 24 g/m², and wherein the yarn is a nylon yarn (e.g. nylon 6 yarn), and optionally wherein the liner is a knitted liner and is made by a knitting machine with a gauge of from 19 to 25;
the garment is a glove and the yarn of the liner has a weight per length of from 38 to 42 Dernier, the palm and/or finger area of the liner in the glove has a weight per area of from 20 to 22 g/m², and wherein the yarn is a nylon yarn (e.g. nylon 6 yarn), and optionally wherein the liner is a knitted liner and is made by a knitting machine with a gauge of from 19 to 25;
the yarn of the liner has a weight per length of from 25 to 50 Dernier, the liner in the garment material or a region thereof has a weight per area of from 15 to 27 g/m², and the first layer comprises from one to three sub-layers of polymeric material;
the garment is a glove and the yarn of the liner has a weight per length of from 25 to 50 Dernier, the palm and/or finger area of the liner in the glove has a weight per area of from 15 to 27 g/m², and the first layer comprises from one to three sub-layers of polymeric material, and optionally wherein the liner is a knitted liner and is made by a knitting machine with a gauge of from 19 to 25; or
the garment is a glove and the yarn of the liner has a weight per length of from 35 to 45 Dernier, the palm and/or finger area of the liner in the glove has a weight per area of from 18 to 24 g/m², wherein the yarn is a nylon yarn (e.g. nylon 6 yarn), the first layer comprises from two sub-layers of polymeric material, and the first layer has a total thickness of 0.001 mm to 0.6 mm, and optionally wherein the liner is a knitted liner and is made by a knitting machine with a gauge of from 19 to 25.

### Third and Subsequent Layers

Preferably the garment material consists essentially of, or consists of, the first layer, the second layer, and the textile layer. Preferably the garment material does not contain other polymeric layers, or any other layers, than the first layer, the second layer, and the textile layer.

The garment material may comprise other layers (i.e. a third and subsequent layers) comprising a polymeric material. The other layers may be applied to the second layer as a fluid polymeric material, and the fluid polymeric material may be solidified to form a third (or subsequent) layer. This may be repeated to build up a desired number of other layers. For example, the method may additionally comprise applying to the third layer a fluid polymeric material and allowing the fluid polymeric material to solidify to thereby form a fourth layer. In general, the method may comprise applying to the n^{th} layer a fluid polymeric material and allowing the fluid polymeric material to solidify to thereby form an (n+1)^{th} layer where n is equal to or greater than 2. The garment material and/or garment may comprise an (n+1)^{th} layer, which is a shaped polymer that is provided at one or more locations on the n^{th} layer, the (n+1) layer taking the shape of the nth layer at said one or more locations, where n is equal to or greater than 2, e.g. 2, 3 or 4.

The fluid polymeric material may be the same as, or different from the polymeric material employed in the first and/or second layer. The third (and subsequent) layers may be built up in the usual way by dipping/immersion in a bath containing a solution or suspension of the polymeric material. The third or subsequent layer may be a shaped polymer provided at one or more locations on the second layer, the third or subsequent layer taking the shape of the second layer at said one or more locations.

The third or subsequent layer may comprise foamed polymeric material, for example, as described in WO2005/088005. A fluid polymeric material that is foamed may be applied to an n^{th} layer, and the fluid foamed polymeric material may be solidified to form an (n+1)^{th} layer where n is equal to or greater than 2. An outer layer of the foamed polymeric material may be removed whereby the surface of the polymeric material has an open porous structure.

The third (and subsequent layers) may be built up using a coagulant. A coagulant is an aqueous or alcoholic solution of electrolytes that may be applied before a fluid polymeric material. Suitable electrolytes include formic acid, acetic acid, calcium chloride, calcium nitrate, zinc chloride or a mixture of two or more of these. Methanol is typically used to provide the alcoholic solution but other alcohols are also suitable, for example, iso-propyl alcohol and ethanol may also be used. In embodiments the coagulant has a concentration (strength) of electrolytes of from 5% to 15% by weight.

In one embodiment the method additionally comprises applying a coagulant to the second (or subsequent) layer, e.g. by immersion in the coagulant. The third (and subsequent layers) may be built up using a plastisol.

### Textile Layer

The textile layer is a skin-contacting layer which makes the material more comfortable for a user or wearer. The textile layer is preferably an outermost layer of the garment material. The textile layer may be provided on the third or subsequent layer. Preferably the textile layer is provided on the second layer. The textile layer may be provided at one or more locations on the underlying (e.g. second, third or subsequent) layer and take the shape of the underlying layer at the one or more locations.

In the context of the glove, the textile layer will typically form the inner surface of the glove. The use of fibres is particularly useful in the final layer to be applied to the former since it can be used to provide the feel of a textile lining. Such a layer is comfortable next to the skin and can be considered to be a skin comfort layer.

The textile layer may be a woven or non-woven material, e.g. fabric. The textile layer preferably comprises or consists of flock, and the textile layer may be referred to as a flock lining. The textile layer may be formed by applying fibres, such as flock, to the second layer. Alternatively, where a third (or subsequent) layer is present, the textile layer may be formed by applying fibres, such as flock, to the third or the subsequent layer.

The fibres may be selected from the list consisting of cotton, rayon, aramid, polyamide (e.g. nylon), polyester, carbon, glass, polyacrylonitrile, polypropylene, and combinations thereof. Preferably the fibres comprise or consist of cotton or nylon flock.

The fibres (e.g. nylon flock) may have a bulk density of 200 g/l or less, such as 150 g/l or less, for example 120 g/l or less. The bulk density may be 50 g/l or more, such as from 50 g/l to 200 g/l. The fibres (e.g. nylon flock) may have a fibre length of 1.0 mm or less, such as 0.7 mm or less. The fibre length may be 0.1 mm or more, or 0.3 mm or more, such as from 0.1 mm to 1.0 mm, or from 0.3 mm to 0.7 mm. The fibres may have a weight per length of from 0.1 to 10 Dernier, such as from 0.1 to 5 Dernier, or from 0.1 to 2.0 Dernier. The fibres may have a weight per length of from 0.5 to 10 Dernier, such as from 1.0 to 10 Dernier, preferably from 0.2 to 10 Dernier. The weight per length of the fibres may be from 0.5 to 5 Dernier, such as from 1.0 to 2.0 Dernier.

The fibres may be applied as a woven or non-woven material, e.g. fabric. The fibres are preferably applied by flocking. Flocking is the process of depositing many small fibre particles (called flock) onto a surface. Preferably the flock is applied by electrostatic flocking, whereby a high-voltage electric field is used to attract the flock to the surface of the glove. Typically, the flock is given a negative charge whilst the substrate is earthed. Flocking may be achieved by air blowing.

In one embodiment a fluid polymeric material having fibres suspended therein is applied and the fluid polymeric material is solidified to form a textile layer having fibres therein. Thus, the textile layer may be a shaped polymer having fibres therein. Thus, the garment may comprise a textile layer that is an inner layer, which is a shaped polymer having fibres (e.g. nylon flock) therein.

In one embodiment the fluid polymeric material comprises 5% or more, or 10% or more, or 15% or more, such as 20% or more of fibres (e.g. nylon flock) by dry weight.

### Former

The garment material may be made by a method comprising providing a first layer, which is a shaped polymer that is fitted on (e.g. mounted on) a former.

Preferably the former is in the shape of the right or the left hand of a human. The production of gloves may use one or more formers in the shape of a right hand and one or more formers in the shape of a left hand. As such, the formers and the resulting gloves may be anatomically designed hand formers. The production of gloves shaped to fit each hand of a wearer (rather than ambidextrous gloves) allows the glove to fit more closely to the wearer's hand. This can reduce the amount of creasing of the glove when on the wearer's hand, which can increase the comfort and dexterity of the user when wearing the gloves compared to similar but ambidextrous gloves. The use of anatomically designed gloves can reduce the risk of the glove catching in machinery, thereby reducing the risk of damage to the wearer's hand during use.

The skilled person will understand that the first layer may be prepared by solidifying a fluid polymeric material in a given shape, e.g. by the use of a former. The former may be made from, metal, ceramic (e.g. porcelain), fibre glass and/or plastic.

A fluid polymeric material may additionally be applied to the former and the fluid polymeric material may be solidified to form the shaped polymer. A coagulant (defined above) may be applied to the former before the fluid polymeric material. The coagulant helps the fluid polymeric material to coagulate on the former.

The shaped polymer can be removed from the former before the liner is applied. However, it is preferred for the shaped polymer to remain on the former while the liner is applied. In this way the former can support the shaped polymer, even if it is very thin. The shaped polymer having the liner applied thereto may remain on the former while the fluidic polymeric material is applied and solidified.

The garment material (or garment or garment section) may be removed from the former. After the garment material has been made it is typically stripped (removed) from the former. The garment material may be inverted when it is removed from the former, such that the first layer becomes the outer surface.

The surface of the former is reflected in the surface of the first layer. Hence, if the former has a smooth outer surface, then the fluid polymeric material in contact with that smooth surface will solidify to form a first layer having a smooth surface. Similarly, if the former has a textured or “rough” surface, the first layer will have a textured surface.

It can be beneficial to have a range of textures in a garment. For example, a former with a grit-like surface can be used to provide a garment material with good grip properties. In one embodiment the garment is a glove wherein the glove has a palm and fingers and the outer surface is textured (e.g. grit-like) at the palm and/or at one or more of the fingers.

The present invention therefore allows the surface of the first layer to tailored to a desired use. In a conventional supported glove a liner is applied to a former so the former does not impart significant texture to the resulting garment.

Some or all of the outer surface of the former may be textured (e.g. bumpy or rough). In embodiments the former has the shape of a glove wherein the glove has a palm and fingers and the outer surface is textured (e.g. grit-like) at the palm and/or at one or more of the fingers.

The former may have the shape of a complete garment, such as a glove (hand-shaped), a sock or a boot (foot-shaped), or the former may have the shape of a section of a garment. If sheets of garment material are required then a former having a flat surface may be employed. The former may have the shape of a complete garment (e.g. a glove) and the method may comprise an additional step of removing the garment from former by turning it inside out.

### DETAILED DESCRIPTION OF THE DRAWINGS

An embodiment of the present invention will now be described by way of example with reference to the accompanying drawings, in which:

FIG. 1 is three photographs of a hand covered by a comparative chemical resistant glove of the prior art;

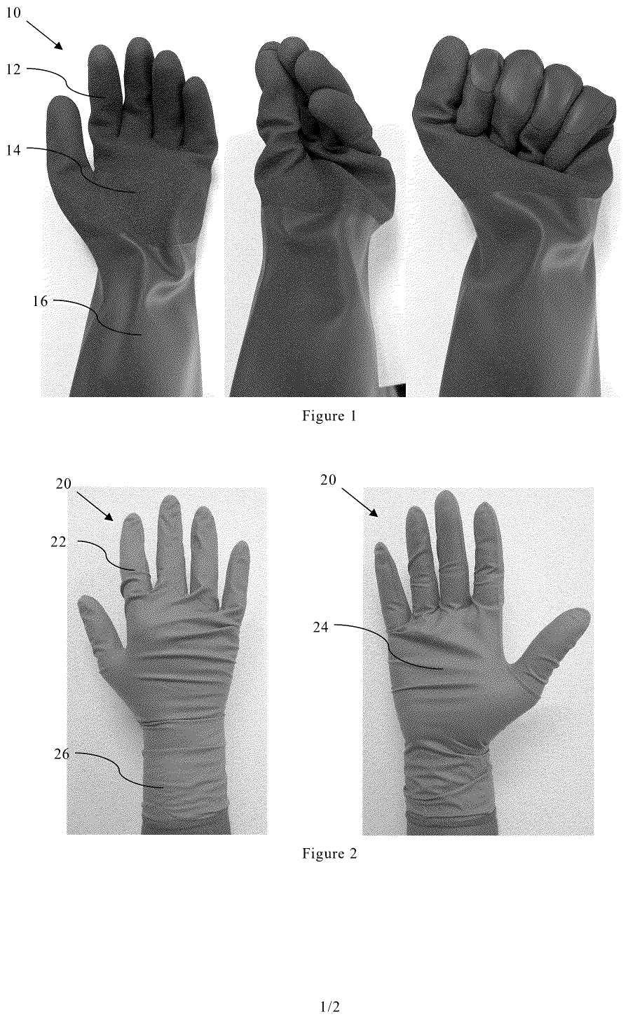

FIG. 2 is two photographs of a comparative single use disposable glove;

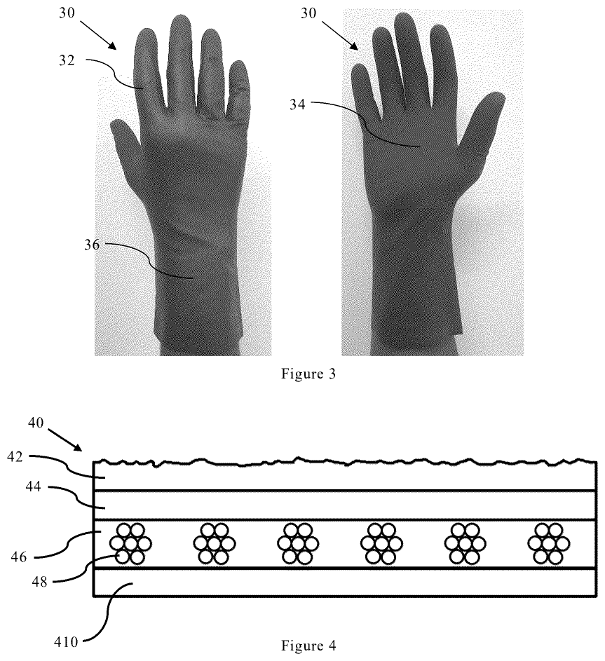

FIG. 3 is two photographs of a glove of the invention; and

FIG. 4 is a cross sectional diagram depicting the layers in the garment material.

FIG. 1 of the accompanying drawings shows three images of a hand covered by a comparative chemical resistant glove 10 of the prior art.

The left-hand image shows hand covered by glove 10 where the hand is in a relaxed, open posture. Finger area 12, palm area 14 and cuff area 16 can be clearly differentiated. The thickness of the garment material in palm area 14 is 1.1 mm. The left-hand image shows that the garment material forms broad waves where it is being creased, due to the inflexibility of the garment material.

The central image shows the hand in glove 10 with the five fingers (including the thumb) in a pinching posture. The broad wave creases over palm area 14 are accentuated by the contraction of the palm of the hand, and broad wave creases can be seen in the garment material covering the thumb.

The right-hand image shows the hand in glove 10 with a closed fist. Owing to the broad wave creases caused by the inflexible material, the user had to use a significant amount of force to form hand into a first when wearing glove 10. Few creases are seen on the external face of glove 10 in this image due to the inflexibility of the garment material.

Glove 10 was found to significantly reduce the dexterity and comfort of the wearer.

FIG. 2 of the accompanying drawings shows the back (opposite palm side) face (left-hand image) and front (palm side) face (right-hand image) of a comparative single-use disposable glove 20 (Ansell Microflex).

The images show hands covered by glove 20 where the hands are in a relaxed, open posture. Finger area 22, palm area 24 and cuff area 26 can be clearly differentiated.

As shown by FIG. 2, comparative single-use disposable glove 20 is significantly creased on the wearer's hand, which causes a reduction in dexterity and comfort to the wearer.

FIG. 3 of the accompanying drawings shows the back (opposite palm side) face (left-hand image) and front (palm side) face (right-hand image) of glove 30 of the invention, which is of the same size of glove and on the hands of the same wearer as shown in FIG. 2.

The images show hands covered by glove 30 where the hands are in a relaxed, open posture. Finger area 32, palm area 34 and cuff area 36 can be clearly differentiated.

The thickness of the garment material in palm area 34 is 0.5 mm. Glove 30 of the invention more readily conforms to changes in shape of the wearer's hand than comparative glove 20.

Glove 30 of the invention is not creased on the hands of the wearer.

Glove 30 of the invention did not significantly reduce the dexterity of the wearer, and provided a significantly higher level of dexterity and comfort compared to comparative gloves 10, 20.

### Examples

### Manufacture of Garment Material

At the first step formers are mounted in a row on a bar termed a “flight bar”. In this example each of the formers has the shape of a complete garment—in this case, a glove. The formers may be made from, for example, metal, porcelain, fibre glass or plastic. The glove is drawn schematically (as a mitten) but would have the shape of a hand in practice. The flight bar moves in a linear direction, from one process station to another at a set speed. Of course, the speed at which the flight bar is set can be varied and there may be several flight bars, each being at a different stage of the process.

A coagulant is applied to the former. This is achieved by immersing the former into a bath or trough containing the coagulant, but it may be achieved by spraying the coagulant onto the former. The coagulant is an aqueous or alcoholic solution of electrolytes. Calcium nitrate is used as the electrolyte in this example. The former is then withdrawn from the bath/trough and may be heated to evaporate excess coagulant, before cooling the dried coagulant.

A first polymeric material is applied to the former, by immersion into a bath or trough containing the first polymeric material. The first polymeric material comprises synthetic latex in this example. The former is then withdrawn and may be rotated to drain off and evaporate excess first polymeric material. This step forms a first sub-layer of the first layer.

A coagulant is again applied to the former, in substantially the same manner as previously described. The coagulant is an aqueous or alcoholic solution of electrolytes. Calcium nitrate is used as the electrolyte in this example. The former is then withdrawn from the bath/trough and may be heated to evaporate excess coagulant, before cooling the dried coagulant.

A second polymeric material is applied to the former, by immersion into a bath or trough containing the second polymeric material. The second polymeric material comprises synthetic latex in this example. The former is then withdrawn and may be rotated to drain off and evaporate excess second polymeric material. This step forms a second sub-layer of the first layer. In this example, the first layer is now complete. The first layer has a total thickness (including the first polymeric material and the second polymeric material) of 0.08-0.19 mm.

The latex of the second sub-layer of the first layer is leeched by immersing the former in hot water. The former is then dried.

A lightweight knitted liner is dressed onto the former that is already coated with the first layer. The liner is made of a 40 Dernier nylon 6 white yarn that included two plies of 12 filaments per ply, and that is knitted with a 21-gauge knitting machine. The liner has a weight per area on the palm area of 20-22 g/m² and a weight per area on the cuff area of 33-35 g/m². In a conventional process a liner would be dressed directly onto a former. However, in the present invention, the liner is dressed onto the polymeric coating of the first layer.

The former, which supports the liner, is immersed in a bath/trough containing a third polymeric material and then withdrawn to allow excess to drain. The liner is coated in the third polymeric material such that interstices in the liner are blocked, and the liner is therefore embedded. The third polymeric material comprises a blend of NBR, neoprene and acrylic latex, which may be considered to be a bonding compound. The third polymeric material and the liner define the second layer. The second layer has a total thickness (including the liner embedded in the third polymeric material) of 0.20-0.25 mm.

The former now supports the liner that is sandwiched between the first and second layers. The former was drained and rotated to remove excess third polymeric material.

Nylon flock was applied to the former using electrostatic coating. The flock had a linear density of 1.53 Dernier and a fibre length of 0.5 mm. The flock was set, and the second polymeric material was dried and cured using conventional steps. Glove was stripped from former before the glove was washed and dried.

FIG. 4 of the accompanying drawings shows a cross sectional diagram depicting the layers in garment material 40 that forms the glove made by the process described above. Garment material 40 has outer layer 42 of synthetic latex. The outer surface of layer 42 is textured due to the texture on the former. Garment material also has second latex layer 44, which is in direct contact with outer layer 42. Layers 42, 44 make up the first layer of the garment material of the invention. Liner 48 is embedded in bonding compound 46. Liner 48 and make up the second layer of the garment material of the invention, which is in direct contact with layer 44 of the first layer of the garment material of the invention. Flock coating 410 corresponds to the textile layer of the garment material of the invention, and is in direct contact with the second layer of the garment material of the invention.

### Dexterity Performance

The dexterity achievable when wearing gloves of the invention was determined under ISO 21420:2020 Clause 5.2. The minimum pin diameter detected through the gloves was the best possible under the testing apparatus (5 mm), and so the gloves achieved the maximum dexterity level (level 5).

The dexterity of a wearer when wearing gloves made of the garment material of the invention was compared with the same wearer when wearing (i) comparative chemical resistant gloves and (ii) comparative single use disposable NBR gloves. The comparative gloves each also achieved level 5 dexterity under the test described above.

The comparative chemical resistant gloves had a liner with a heavier yarn and a greater weight per area than required by the garment material of the invention.

The gloves of the invention provided the wearer with a significantly higher level of dexterity than the comparative chemical resistant gloves.

The level of dexterity achieved with gloves of the invention was similar to that achieved with conventional single use disposable gloves.

### Mechanical Resilience

The mechanical resistance properties of gloves made of the garment material of the invention were tested and compared to two unsupported NBR gloves. Specifically, the abrasion resistance, bladecut resistance and tear resistance of the gloves were determined. The results are shown in the table below.

| | Comparative | Comparative | |
|---|---|---|---|
| EN | unsupported | unsupported | Glove of the |
| 388: 2016 + A1: 2018 | NBR glove 1 | NBR glove 2 | Invention |
| 6.1: Abrasion | 750-850 | 40-50 | 1000-1500 |
| resistance (Cycles) | | | |
| 6.2: Bladecut | 1.07 | 1.07 | 1.13 |
| resistance (Index) | | | |
| 6.4: Tear | 1.01 | 0.4 | 7.18 |
| resistance (N) | | | |

The glove made of the garment material of the invention had an abrasion resistance that was 63-2800% better than unsupported NBR gloves.

The glove made of the garment material of the invention had a bladecut resistance of 6% better than the unsupported NBR gloves.

The glove made of the garment material of the invention had a tear resistance of 600-1700% better than the unsupported NBR gloves.

Therefore, gloves made of the garment material of the invention have significantly better physical properties than conventional gloves, whilst not providing a significant detriment to the dexterity of the user.

### Chemical Resistance

The chemical resistance properties of gloves made of the garment material of the invention were tested and compared to two supported chemically resistant gloves. Specifically, the chemical resistance to hydrofluoric acid, sodium hydroxide and iso-octane was determined for gloves made of the garment material of the invention.

| | Minimum breakthrough time (minutes) | | |
|---|---|---|---|
| EN 16523- | Comparative | Comparative | |
| 1: 2015 + A1: 2018 | supported | supported | |
| (chemical | chemically | chemically | Glove of the |
| permeation) | resistant glove 1 | resistant glove 2 | Invention |
| Hydrofluoric acid | Not tested | Not tested | 23 |
| (40%) | | | |
| Sodium hydroxide | >480 | >480 | >480 |
| (40%) | | | |
| Iso-octane | >480 | Not tested | >480 |

The gloves of the invention provided significant resistance to hydrofluoric acid. The hydrofluoric acid resistance of the comparative gloves was not tested.

The glove made of the garment material of the invention provided the highest possible resistance to sodium hydroxide under the testing conditions, which was as high as that for either comparative supported chemically resistant glove tested.

The glove made of the garment material of the invention provided the highest possible resistance to iso-octane under the testing conditions, which was as high as that for the comparative supported chemically resistant glove that was tested.

Therefore, gloves made of the garment material of the invention provide the surprising combination of benefits of excellent chemical resistance, whilst not providing a significant detriment to the dexterity of the user, and also providing significantly better physical properties than conventional gloves.

1. A garment material comprising:
a first layer, wherein the first layer is a shaped polymer defining a shape of the first layer;
a second layer, wherein the second layer is a shaped polymer that is provided at one or more locations on the first layer, the second layer taking the shape of the first layer at said one or more locations; and
a textile layer;
wherein the second layer is located between the first layer and the textile layer;
wherein the second layer comprises a liner embedded in the shaped polymer of the second layer, the liner being formed of yarn and there are interstices through the liner, and wherein:
(a) the yarn of the liner has a weight per length of 10 to 60 Dernier; and
(b) the liner has a weight per area in the garment material or in a region of the garment material that is from 5 to 35 g/m².

2. The garment material of claim 1, wherein the yarn of the liner has a weight per length of from 25 to 50 Dernier, and the liner in the garment material or a region thereof has a weight per area of from 15 to 27 g/m².

3. The garment material of claim 2, wherein the yarn of the liner has a weight per length of from 35 to 45 Dernier, and the liner in the garment material or a region thereof has a weight per area of from 18 to 24 g/m².

4. The garment material of claim 1, wherein the liner is a knitted liner and is made by a knitting machine with a gauge of from 19 to 25.

5. The garment material of claim 1, wherein the thickness of the garment material is from 0.1 mm to 1.0 mm.

6. The garment material of claim 5, wherein the thickness of the garment material is from 0.3 mm to 0.7 mm.

7. The garment material of claim 1, wherein the first layer comprises two sub-layers of polymeric material.

8. The garment material of claim 1, wherein the first layer has a thickness of 0.3 mm or less.

9. The garment material of claim 1, wherein the second layer has a thickness of 0.3 mm or less.

10. The garment material of claim 1, wherein the yarn is a nylon yarn.

11. The garment material of claim 10, wherein the yarn of the liner has a weight per length of from 38 to 42 Dernier, and the liner in the garment material or a region thereof has a weight per area of from 20 to 22 g/m², and wherein the liner is a knitted liner and is made by a knitting machine with a gauge of from 19 to 25.

12. The garment material of claim 1, wherein the garment material consists of the first layer, the second layer and the textile layer.

13. The garment material of claim 1, wherein the polymer of the first layer is selected from the group consisting of nitrile latex, natural latex, neoprene, and butyl rubber and the polymer of the second layer is selected from the group consisting of nitrile latex, natural latex, neoprene, and butyl rubber.

14. A garment comprising the garment material of claim 1.

15. The garment of claim 14, wherein the garment is a glove.

16. The garment of claim 15, wherein the liner has a weight per area in a palm and/or finger region of the glove of from 18 to 24 g/m².

17. The garment material of claim 15, wherein the glove has a palm or finger region comprising the garment material which has a thickness from 0.1 mm to 1.0 mm.

18. The garment material of claim 17, wherein the thickness of the garment material in the region of the palm and/or fingers of the glove is from 0.3 mm to 0.7 mm.

19. The garment of claim 15, wherein:
the yarn of the liner has a weight per length of from 35 to 45 Dernier, the liner in the glove has a palm and/or finger area and the palm and/or finger area of the liner in the glove has a weight per area of from 18 to 24 g/m², the yarn is a nylon yarn, the liner is a knitted liner and is made by a knitting machine with a gauge of from 19 to 25, the first layer comprises from two sub-layers of polymeric material, and the first layer has a total thickness of 0.001 mm to 0.6 mm.

20. A method of making a garment material, the method comprising:
providing a first layer, which is a shaped polymer;
applying a liner to the first layer, wherein the liner is formed of yarn, and there are interstices through the liner;
applying a fluid polymeric material to the liner such that the fluid polymeric material permeates the interstices of the liner;
allowing the fluid polymeric material to solidify to thereby form a second layer comprising the liner embedded in the solid polymeric material; and
applying fibres to form a textile layer, wherein:
(a) the yarn of the liner has a weight per length of 10 to 60 Dernier; and
the liner has a weight per area in the garment material or a region of the garment material that is from 5 to 35 g/m².
